(19) United States
(12) Patent Application Publication
(10) Pub. No.: US 2013/0046803 A1
(43) Pub. Date: Feb. 21, 2013

(54) DITHER-AWARE IMAGE CODING

(71) Applicants: Manu Parmar, Sunnyvale, CA (US); Jennifer Lee Gille, Menlo Park, CA (US); Koorosh Aflatooni, Cupertino, CA (US)

(72) Inventors: Manu Parmar, Sunnyvale, CA (US); Jennifer Lee Gille, Menlo Park, CA (US); Koorosh Aflatooni, Cupertino, CA (US)

(73) Assignee: Qualcomm MEMS Technologies, San Diego, CA (US)

(21) Appl. No.: 13/212,975

(22) Filed: Aug. 18, 2011

(51) Int. Cl. G06F 17/14

(52) U.S. Cl. 708/203; 708/401

(57) ABSTRACT

This disclosure provides implementations of dither-aware image coding processes, devices, apparatus, and systems. In one aspect, a portion of received image data is selected. First spatial domain values in the selected portion of the image data are transformed to first transform domain coefficients. Second spatial domain values in a designated dither matrix are transformed to second transform domain coefficients. A ratio of each of the first transform domain coefficients to a respective second transform domain coefficient is determined. The first transform domain coefficients are selectively coded in accordance with the determined ratios to define coded first transform domain coefficients. A reverse transformation is performed to transform the coded first transform domain coefficients to third spatial domain values defining a coded portion of the image data. By way of example, transformations such as discreet cosine transforms or discreet wavelet transforms can be used.

### TECHNICAL FIELD

This disclosure relates to image coding and coding in relation to an image pipeline.

### DESCRIPTION OF THE RELATED TECHNOLOGY

Electromechanical systems include devices having electrical and mechanical elements, transducers such as actuators and sensors, optical components (e.g., mirrors), and electronics. Electromechanical systems can be manufactured at a variety of scales including, but not limited to, microscales and nanoscales. For example, microelectromechanical systems (MEMS) devices can include structures having sizes ranging from about one micron to hundreds of microns or more. Nanoelectromechanical systems (NEMS) devices can include structures having sizes smaller than one micron including, for example, sizes smaller than several hundred nanometers. Electromechanical elements may be created using deposition, etching, lithography, and/or other micromachining processes that etch away parts of substrates and/or deposited material layers, or that add layers to form electrical, mechanical, and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

A display device can include a collection of IMODs. Joint Photographic Experts Group (JPEG) compression, a.k.a. JPEG encoding, is a widely used conventional compression scheme for encoding spatial domain image content to be displayed on the display device. JPEG compression generally quantizes high frequency spatial information without significant perceptual loss. Stages in a JPEG compression scheme can include quantizing 2-Dimensional (2D) Discrete Cosine Transform (DCT) coefficients based on their perceptual significance, such that higher frequency coefficients are quantized more aggressively than lower frequency coefficients. Quantization of DCT coefficients during JPEG compression can be based on a quantization table, which applies different weights to different frequency coefficients. Lower frequency components, considered more visually important, can be encoded with more bits, while higher frequency components, considered less visually important, can be encoded with fewer bits. Thus, by encoding the lower frequency components with more bits, the encoded lower frequency coefficients can have more precision.

### SUMMARY

The processes, devices, apparatus, modules, and systems of the disclosure each have several innovative aspects, no single one of which is solely responsible for the desirable attributes disclosed herein.

Disclosed are implementations of dither-aware image coding processes, devices, apparatus, modules, and systems.

According to one innovative aspect of the subject matter described in this disclosure, image data is received, and a portion of the received image data is selected. A first transformation is performed to transform a first plurality of spatial domain values in the selected portion of the image data to a first plurality of transform domain coefficients. A second plurality of transform domain coefficients is accessed. The second transform domain coefficients are defined by a second transformation from a second plurality of spatial domain values in a designated dither matrix. A ratio of each of the first transform domain coefficients to a respective second transform domain coefficient is determined. The first transform domain coefficients are selectively coded in accordance with the determined ratios to define a plurality of coded first transform domain coefficients. A reverse transformation is performed to transform the coded first transform domain coefficients to a third plurality of spatial domain values defining a coded portion of the image data. By way of example, transformations such as discreet cosine transforms or discreet wavelet transforms can be used.

In some implementations, selectively coding the first transform domain coefficients includes comparing the determined ratios with a threshold, and discarding the first transform domain coefficients associated with the determined ratios if the determined ratios are less than the threshold. In some other implementations, selectively coding the first transform domain coefficients includes selectively quantizing the first transform domain coefficients. For example, the determined ratios can be compared with the threshold, and the first transform domain coefficients associated with the determined ratios can be quantized with a number of bits representing a function of the respective determined ratio if the determined ratio is less than the threshold.

According to another innovative aspect of the subject matter described in this disclosure, apparatus includes a selecting module configured to select a portion of received image data. An image transformation module is configured to perform a first transformation from a first plurality of spatial domain values in the selected portion of the image data to a first plurality of transform domain coefficients. A ratio determining module is configured to determine a ratio of each of the first transform domain coefficients with a respective one of a second plurality of transform domain coefficients. The second transform domain coefficients are defined by a second transformation from a second plurality of spatial domain values in a designated dither matrix. A selective coding module is configured to selectively code the first transform domain coefficients in accordance with the determined ratios to define a plurality of coded first transform domain coefficients. A reverse transformation module is configured to perform a reverse transformation from the coded first transform domain coefficients to a third plurality of spatial domain values defining a coded portion of the image data.

In some implementations, the image data has a first tone-level, and the dither matrix is associated with an image pipeline of a display device having a second tone-level lower than the first tone-level.

In some implementations, the apparatus further includes a display and a processor configured to communicate with a display. The processor is configured to process image data. The apparatus further includes a memory device configured to communicate with the processor. In some implementations, the apparatus further includes a driver circuit configured to send at least one signal to the display, and a controller configured to send at least a portion of the image data to the driver circuit.

According to another innovative aspect of the subject matter described in this disclosure, apparatus includes means for receiving image data. The image data has a first tone-level. The apparatus further includes means for performing dither-aware coding on the image data for transferring the data to a display device having a second tone-level lower than the first tone-level. In some implementations, the means for performing dither-aware coding includes means for selecting a portion of the received image data. The apparatus also includes means for performing a first transformation from a first plurality of spatial domain values in the selected portion of the image data to a first plurality of transform domain coefficients. The apparatus further includes means for determining a ratio of each of the first transform domain coefficients with a respective one of a second plurality of transform domain coefficients. The second transform domain coefficients are defined by a second transformation from a second plurality of spatial domain values in a designated dither matrix. The apparatus further includes means for selectively coding the first transform domain coefficients in accordance with the determined ratios to define a plurality of coded first transform domain coefficients. The apparatus further includes means for performing a reverse transformation from the coded first transform domain coefficients to a third plurality of spatial domain values defining a coded portion of the image data.

According to another innovative aspect of the subject matter described in this disclosure, a non-transitory tangible computer-readable storage medium stores instructions executable by a computer to perform a process. The process includes: receiving image data; selecting a portion of the image data; performing a first transformation from a first plurality of spatial domain values in the selected portion of the image data to a first plurality of transform domain coefficients; accessing a second plurality of transform domain coefficients defined by a second transformation from a second plurality of spatial domain values in a designated dither matrix; determining a ratio of each of the first transform domain coefficients with a respective one of the second transform domain coefficients; selectively coding the first transform domain coefficients in accordance with the determined ratios to define a plurality of coded first transform domain coefficients; and performing a reverse transformation from the coded first transform domain coefficients to a third plurality of spatial domain values defining a coded portion of the image data.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

The included drawings are for illustrative purposes and serve only to provide examples of possible structures and configurations of the disclosed processes, devices, apparatus, modules, and systems.

FIG. 1 shows an example of an image pipeline.

FIG. 2 shows an example of a set of DCT coefficients of a dither matrix.

FIGS. 3A and 3B show examples of image processing apparatus incorporating dither-aware image coding.

FIG. 4 shows an example of a flow diagram illustrating a dither-aware image coding process.

FIGS. 5A and 5B show examples of flow diagrams illustrating a selective coding process.

FIG. 6 shows an example of apparatus configured to perform dither-aware image coding.

FIG. 7A shows an example of an isometric view depicting two adjacent pixels in a series of pixels of an interferometric modulator (IMOD) display device.

FIG. 7B shows an example of a system block diagram illustrating an electronic device incorporating a 3×3 interferometric modulator display.

FIGS. 8A and 8B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways.

Some display devices are capable of displaying high tone-level digital image content in a spatial domain color space, such as standard Red, Green, and Blue (sRGB). For instance, image data in the sRGB color space can be encoded with 24 bits per pixel, corresponding to 8 bits per respective Red, Green, or Blue color channel. That is, at each pixel, there are 8 bits of information for each of the 3 channels. For instance, a sRGB color monitor, such as a liquid crystal display (LCD) monitor, can display 24 bits per pixel. Because there are 2⁸=256 possible strings with 8 bits, a sRGB color monitor can provide up to 256 levels of intensity per channel. With such 3-color display devices, there can be 2⁸×2⁸×2⁸=over 16 million different combined intensity variations, representing the total number of different colors that the display device can generate. However, to reduce computational complexity and processing demands, and to reduce hardware costs, some other modern displays are intentionally engineered to have lower tone-levels and have a fewer number of colors that can be shown. For example, some displays are configured to display 6 bits per pixel, corresponding to 2 bits per Red, Green, or Blue color channel, i.e., 2²=4 levels of intensity per color channel. Much of the information in the content of a higher tone-level image, such as sRGB with 256 levels of intensity per color channel, may not be faithfully reproduced on such lower tone-level display devices.

With lower tone-level display devices such as those displaying 2 bits/4 intensity levels per color channel, any higher tone-level image delivered to the display device will automatically be reduced to 2 bits per channel. In light of this fact, image data to be displayed can be coded before being delivered to the display device, using the techniques disclosed herein, so the image data to be delivered does not include superfluous information.

An image pipeline generally refers to components that can be connected between an image source (such as a camera, a scanner, a network interface, or a storage medium) and an image rendering device (such as a display of a portable electronic device, a computer monitor, or a television). The components of the image pipeline can be configured as stages for performing desired intermediate digital image processing on image data received in the pipeline. Image pipeline stages can include, by way of example, image sensor correction, noise reduction, image scaling, gamma correction, image enhancement, color space conversion, chroma subsampling, framerate conversion, image compression/video compression, and computer data storage/data transmission.

One of the processing stages of image pipelines disclosed herein is dithering. In some implementations of a dithering stage, a set of intensity values generally referred to as dither is added to individual blocks of image data. The same set of values, often a form of noise used to randomize quantization error, is applied to each block to prevent large-scale patterns such as banding in images. Dither can be used in processing of both digital still image and video data, and it is often used in computer graphics to create the illusion of color depth in images with a limited color palette. In a dithered image, colors not available in the palette are approximated by a diffusion of colored pixels from within the available palette. The human eye perceives the diffusion as a mixture of the colors in the palette.

When a lower tone-level display device reduces higher tone-resolution image data, e.g., 8 bits per channel to 2 bits per channel, simply truncating the bits can result in undesirable artifacts such as contouring and/or banding. Dithering can compensate for these artifacts. Dithering is performed by adding noise to image data before quantizing the image data from a larger number of bits (e.g., 8 bits) to a smaller number of bits (e.g., 2 bits). A dither matrix can be implemented with a known set of coefficients configured to add noise to certain frequency coefficients, as further described herein. Because the dither matrix is known, it can be determined what dithering will do to an image before the image is received in the pipeline.

Disclosed are implementations of processes and related apparatus, devices, modules, and systems that provide for intelligent coding, a.k.a. dither-aware coding, of image content. In some implementations, the disclosed techniques include coding, e.g., discarding or quantizing, selected information in the image content. Using the disclosed coding techniques, certain information in the image content can be identified as not likely to be transmitted accurately by an image pipeline of a display with a lower tone-depth than the image content. Such information can be selectively coded.

In some implementations, the disclosed coding techniques can be performed in addition to and apart from an image or video data compression process, such as a JPEG compression process. For instance, the disclosed techniques can be performed as a pre-JPEG compression stage or a post-JPEG compression stage. When performed as a pre-compression stage, in some implementations, coded image data can be passed on to a JPEG encoder for further compression. In some implementations, where these stages are reversed, i.e., the disclosed coding techniques are performed after JPEG compression, compressed image data from the JPEG encoder is provided as input image data to the disclosed dither-aware coding operations described below.

In some implementations, operations of the disclosed dither-aware coding techniques generally include the following:

1) receive input image data having spatial domain values, for instance, in the sRGB color space;

2) tile input image data into portions, such as 8×8 blocks;

3) for each block, perform a transformation from the spatial domain values to transform domain coefficients; e.g., compute 2D DCT coefficients for each color component, e.g., Red, Green, and Blue;

4) use a dither matrix having known spatial domain values, for instance, in the sRGB color space, where the dither matrix is associated with a designated image pipeline;

5) perform a transformation on the spatial domain values of the dither matrix to transform domain coefficients such as 2D DCT coefficients;

6) compute the ratio of input image energy to dither energy at each corresponding transform domain coefficient of the input image data block and the dither matrix;

7) selectively code the transform domain coefficients of the input image data block in accordance with the determined ratios, for example, by performing one or more of the following operations:
a) Hard Thresholding: if dither energy at a particular frequency is greater that T x image energy, where T is a designated threshold, then discard, i.e., set to zero, the transform domain coefficient of the input image data block at that frequency;
b) Soft Thresholding: if dither energy at a particular frequency is greater that T x image energy, where T is a designated threshold, then quantize the transform domain coefficient of the input image data block with a number of bits representing some function of the ratio; and

8) perform a reverse transformation from the coded transform domain coefficients of the input image data block to spatial domain values to define a coded block of image data; for example, recover the sRGB color space image from the coded transform domain coefficients by performing an inverse 2D DCT operation.

In implementations where the disclosed coding techniques are performed on pre-JPEG compressed image data, the coded image data output from operation 8) can be provided as an input to a JPEG encoder, which is configured to discard perceptually insignificant data.

Particular implementations of the subject matter described in this disclosure can be implemented to realize one or more of the following potential advantages. With the disclosed dither-aware coding techniques, it is possible to improve compression rates without reducing perceived image quality by discarding or quantizing information that cannot be faithfully reproduced on a display. In some examples, such improvements can be achieved by discarding or quantizing DCT coefficients of images that will be corrupted by a color image pipeline having designated characteristics. In some examples, two stages of processing, i.e., dither-aware coding before or after JPEG compression, as outlined above, can yield better compression rates than stand-alone JPEG compression for similar perceptual image quality.

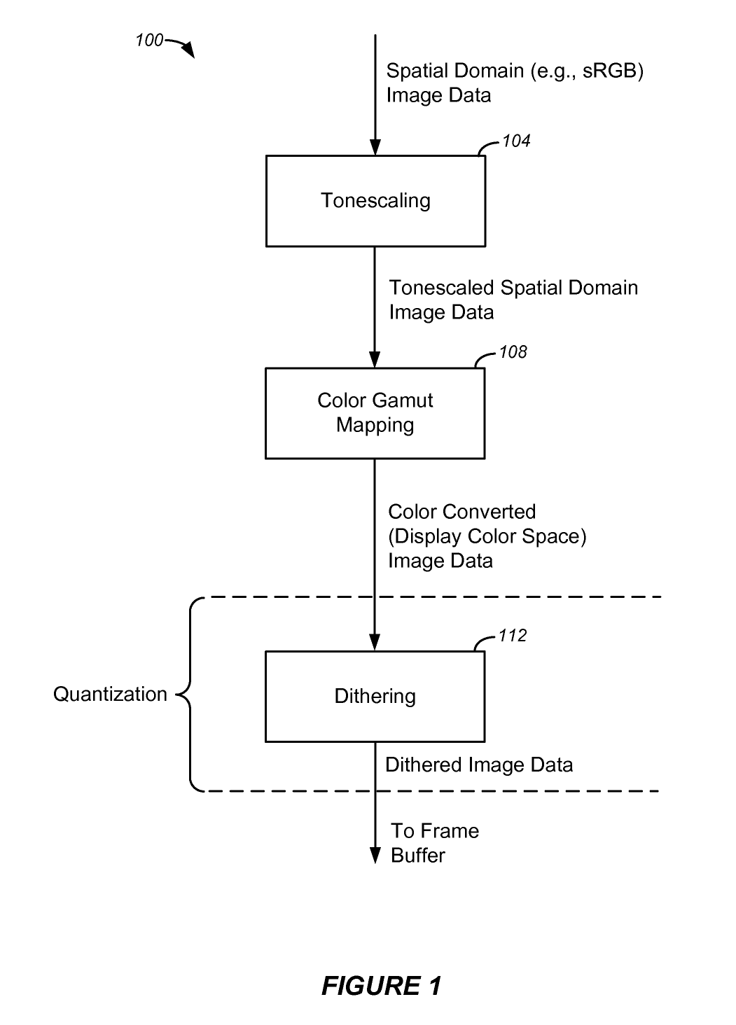

FIG. 1 shows an example of an image pipeline, which includes one or more hardware and/or software processing components, coupled to receive input image data, process the image data, and output processed image data. For example, the image pipeline 100 can be coupled to receive data from an image source, such as a camera, a scanner, or the rendering engine in a computer game, process the data, and output the processed data to an image rendering device such as a computer display or notepad display. As illustrated in FIG. 1, the image pipeline 100 includes processing stages 104, 108, and 112, configured to perform respective digital image processing operations. By way of example, one or more stages of the image/video pipeline may be implemented as computer software, in a digital signal processor, on a Field-Programmable Gate Array (FPGA) or as a fixed-function Application Specific Integrated Circuit (ASIC), or some combination thereof. In addition, analog circuits can be used to perform the processing operations. Part or all of the stages can be implemented in the same device, such as a tablet or digital camera. In some other implementations, stages or the pipeline are implemented in different devices, such as a computer and a printer.

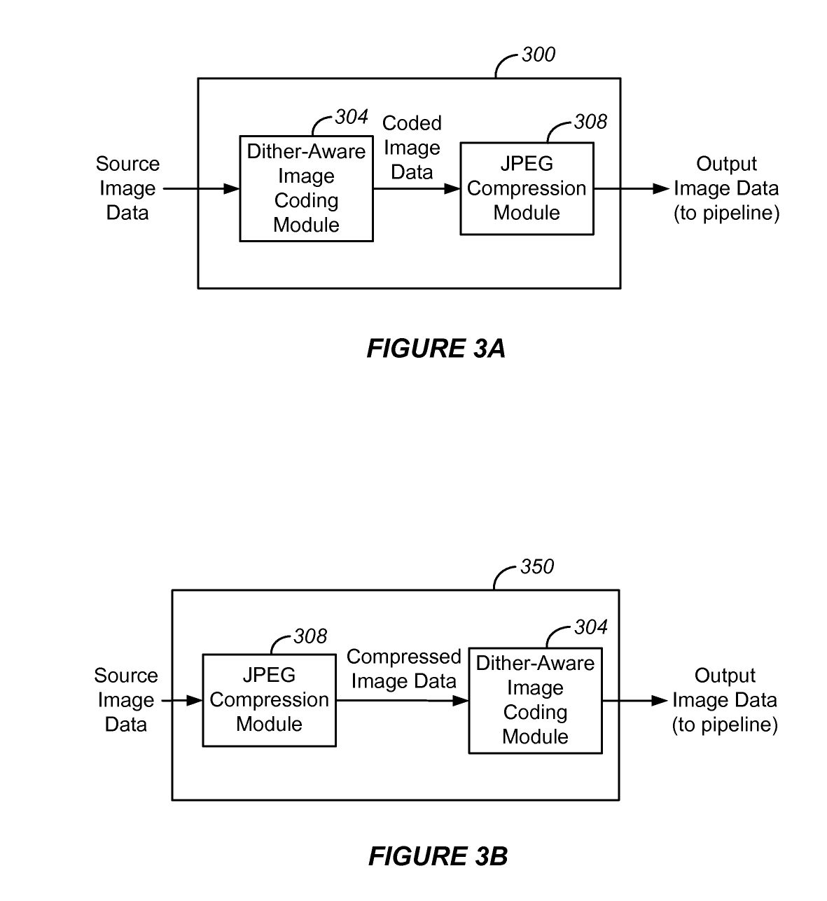

In FIG. 1, input image data in a spatial domain such as the sRGB color space is provided to an image pipeline 100 including several processing stages 104, 108, and 112. The input image data can be uncompressed, in some implementations. In some other implementations, the input image data may be compressed using any of a variety of compression schemes, such as JPEG encoding. For example, the spatial domain image data provided as an input to the image pipeline 100 can be output from a JPEG compression module, as shown in FIG. 3A. In another example, the input image data of FIG. 1 is output from a dither-aware image coding module, as shown in FIG. 3B, as described in greater detail below. In FIG. 1, the input image data can be received directly from such a processing module of FIG. 3A or FIG. 3B, received over a data network, and/or retrieved from a suitable memory device such as RAM or a storage medium such as a database. Other various memory and storage media can be used to store and provide the input image data, such as flash drives, hard drives, and Digital Versatile Discs (DVDs). The input image data in FIG. 1 can be still image data or frames of video data, depending on the desired implementation.

In FIG. 1, in this example, the input spatial domain image data is first provided to a tonescaling stage 104 at which the tonescale of the image data can be adjusted. For instance, operations such as green crush, white boost, and others can be performed at stage 104. Persons having ordinary skill in the art will appreciate that the input image data has a gamma, and gamma correction can be performed on the image data at stage 104. For example, in some implementations, the input image data can be de-gamma'ed to make the intensity levels of the image data substantially linear while retaining about the same number of bits and levels per color channel, e.g., 8 bits and 256 levels.

In FIG. 1, following the tonescaling operation(s) of stage 104, the tonescaled image data is provided to stage 108, at which color operations in the form of color gamut mapping are performed. These color gamut mapping operations generally include conversion of colors from the spatial domain of the input image data, such as sRGB, to a color spatial domain of the display device on which the output image data from image pipeline 100 is to be displayed. In some other implementations, the color gamut mapping of stage 108 can be omitted, for instance, when the display color space is the same as the input image data, such as sRGB.

In FIG. 1, following the color gamut mapping operation(s) of stage 108, the color converted image data from stage 108 is provided to a dithering stage 112. At stage 112, the color converted image data is quantized to an appropriate number of bits to be displayed by the display device. For example, 8-bit data in each channel can be quantized to 2-bit data. In the example of image pipeline 100, dithering at stage 112 is performed as part of a quantization operation. In some implementations, a dither matrix, also referred to herein as a dither mask, is applied to the color converted image data received from stage 108. The dither matrix generally refers to a threshold map to be applied to image data. For example, application of the dither matrix at stage 112 can cause some of the pixels of the color converted image data to be rendered at a different color, depending on how far in between the color is of available color entries. Such a threshold map is commonly referred to by persons of ordinary skill in the art as the Bayer matrix. When the dithering operation is matrix-based, the dither matrix can include ordered dither or some form of noise having spatial domain values in a domain such as sRGB. For example, the dither matrix can be an 8×8, 16×16, 32×32, etc., set of intensity values that are added to a corresponding block of the same size of the image data. In general, the dither matrix can be added to the color converted image data, and the resulting information can be quantized to a designated number of bits per pixel (bpp). The dithered image data output from stage 112 can then be provided to a frame buffer of a display device.

In the example of FIG. 1, dithering at stage 112 is performed after color gamut mapping at stage 108. Thus, in some implementations, when the dither matrix is in the pre-converted spatial domain, such as sRGB, the dither matrix can be converted to the same domain as the color converted image data before being applied at dithering stage 112. In some other implementations, when the image data received at stage 112 is in the same spatial domain as the dither matrix, such as sRGB, such a conversion of the dither matrix is not performed. By way of example, color conversions from the color space of the input image data to the color space of the display can be performed in accordance with the CIE (International Commission on Illumination) 1931 XYZ color space. Colors in the sRGB domain can be represented in the XYZ 3-dimensional coordinate system with X, Y, and Z values. The same CIE XYZ conversion can be applied to the dither matrix so that the dither matrix is in the same color space as the image data to which the dither matrix will be applied.

In one example of the image pipeline 100 of FIG. 1, x is a 24 bpp tonescaled image output from tonescaling stage 104. Mathematically, the dithered image data y output from dithering stage 112, in the spatial domain, can be written as:

y=ƒ₆(ax+d),

where ƒ₆(·) is a function that quantizes data to 6 bpp by thresholding, and a is a linear operator applied at color gamut mapping stage 108 that transforms x to the color space and preserves the range of ax+d to be the same as x. The variable d is a spatial domain representation of the dither matrix, described in greater detail below. The ƒ₆(·) function can be approximated as quantization noise n, which can be modeled as independent, uniformly distributed, additive white noise. Thus, in one example, the dithered image data y output from stage 112 can be approximated as:

y=ax+d+n,

where n is the noise component. In a transform domain such as the DCT space, the output dithered image can be modeled as:

Y=aX+D+N,

where upper-case letters denote DCT coefficients. In this example, N is white noise and contributes energy to all of the elements of Y, and D, the DCT version of the dither matrix, has significant energy only in particular designated coefficients.

The sequence of stages in image pipeline 100 of FIG. 1 represents one possible implementation of image pipelines capable of being used with the disclosed implementations. One or more of the stages 104, 108, and 112, can be omitted, in some implementations, and the sequence of stages can be altered. Additional stages can be included in the pipeline 100 in various implementations, such as color sharpening and/or noise reduction, before the output image data is provided to a frame buffer of a display.

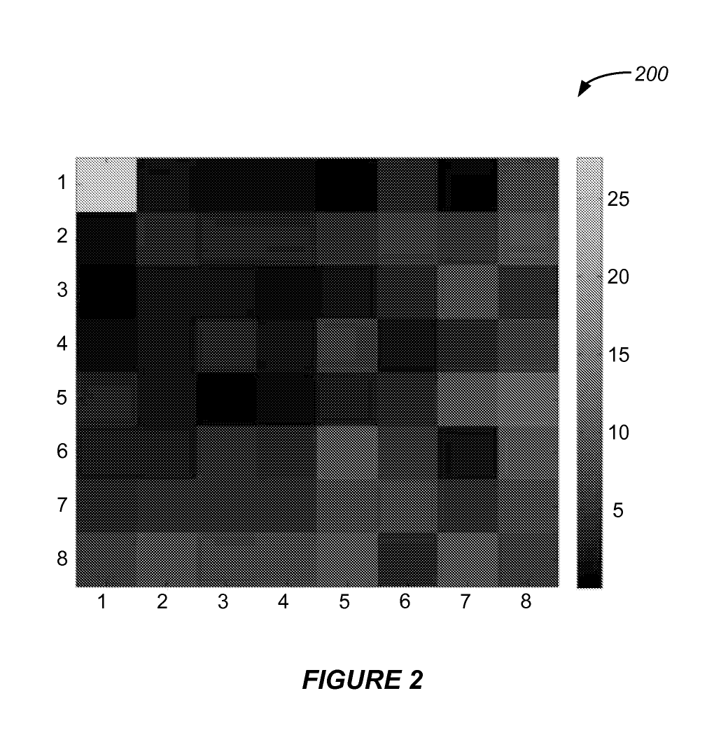

FIG. 2 shows an example of a set of DCT coefficients for a dither matrix. In particular, FIG. 2 shows an example of a DCT coefficient matrix D 200 for a particular 8×8 dither matrix d, as described above. In this example, the matrix 200 has a designated pattern, in which each of the 64 coefficients has a known intensity value. In this example, the dither matrix 200 is designed specifically to add noise to higher frequency components of ax since such components are less visible. So, in the DCT space, the higher frequency components can have appreciably higher energy than the lower frequency components, yet there can be significant energy in some of the lower frequency components. The coefficients of matrix D can add error to the corresponding components of X, using the equations above.

The disclosed image coding techniques can be performed before or after JPEG encoding of image data. For example, spatial domain image data can be encoded using standard JPEG compression schemes, returned to a spatial domain such as sRGB, and then encoded using dither-aware image coding. By the same token, spatial domain image data can first be encoded using dither-aware image coding, and then encoded as a JPEG image.

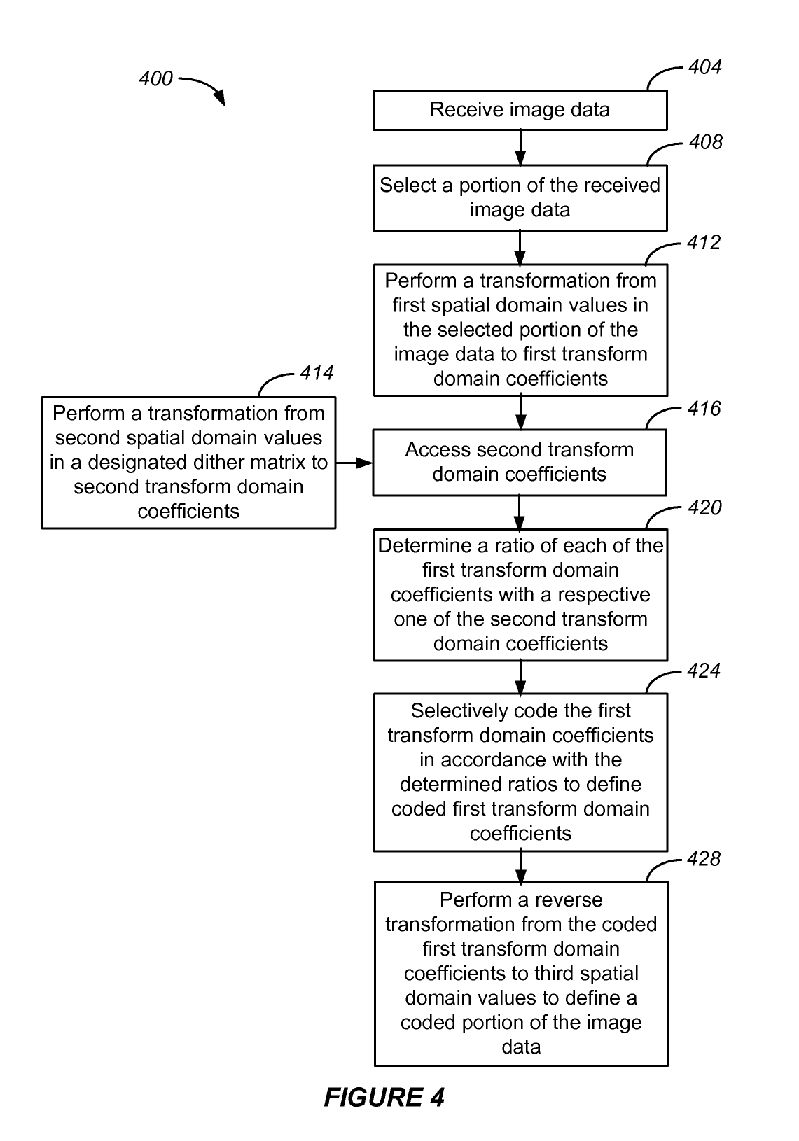

FIG. 3A shows an example of an image processing apparatus incorporating dither-aware image coding. In the apparatus 300 of FIG. 3A, source image data in a spatial domain such as sRGB is first delivered to a dither-aware image coding module 304, which is configured to perform coding processes disclosed herein, for instance, with reference to FIG. 4. The source image data can be received over a wired or wireless network or retrieved from a suitable storage medium, as explained above. The result of the image coding processes performed at module 304 is coded image data, which is output from dither-aware image coding module 304 and provided to a JPEG compression module 308, in this example. The coded image data can then be compressed by JPEG compression module 308 using JPEG encoding techniques and output for further processing. For example, the output image data from JPEG compression module 308 can be provided as input image data to an image pipeline as described above with reference to FIG. 1.

In FIG. 3A, in some implementations, JPEG compression module 308 can be configured to implement a JPEG compression scheme, which includes: 1) tiling an input sRGB image, that is, dividing the image into two or more smaller sub-images, such as 8×8 blocks; 2) converting the blocks of sRGB image data to the YUV color space; 3) transforming the blocks to the frequency domain by determining a 2D DCT of each block; 4) quantizing DCT coefficients based on their perceptual significance, such that higher frequency coefficients are quantized more aggressively than lower frequency coefficients, and similar frequency chrominance coefficients are quantized more aggressively than corresponding luminance component coefficients; 5) encoding coefficients in two stages, e.g., running length coding followed by entropy coding; and 6) performing a reverse 2D DCT operation to return the encoded frequency domain image data to the sRGB domain.

FIG. 3B shows another example of an image processing apparatus incorporating dither-aware image coding. In the apparatus 350 of FIG. 3B, source image data in a spatial domain is first provided to JPEG compression module 308, for JPEG encoding as described above. The resulting compressed image data output from JPEG compression module 308 is then delivered to dither-aware image coding module 304, in this example. Thus, in FIG. 3B, dither-aware image coding module 304 codes the compressed image data received from JPEG compression module 308. The dither-aware coding module 304 of FIG. 3B is configured to perform the same operations as in FIG. 3A. The resulting coded image data output from dither-aware image coding module 304 can be transmitted for further processing, for instance, as input image data to an image pipeline as described above with reference to FIG. 1.

FIG. 4 shows an example of a flow diagram illustrating a dither-aware image coding process. In block 404, process 400 begins with the receipt of input image data, for example, at dither-aware image coding module 304 of FIG. 3A or FIG. 3B. In some implementations, the received image data has spatial domain values, for instance, in the standard Red, Green, and Blue (sRGB) color space. In block 408, a portion of the received image data is selected. For instance, the image data received at block 404 can be apportioned, e.g., tiled into data blocks of a suitable size, such as 4×4, 8×8, 32×32, 64×64, etc., and one or more of these apportioned blocks can be selected. Additional ones of the apportioned blocks of the image also can be selected for further processing, as described below, such that the entire image data is processed, as described in greater detail below.

In block 412, a transformation is performed on spatial domain values in the selected portion of the image data. That is, the spatial domain values are transformed to a first set of transform domain coefficients. For example, a 2D DCT operation can be performed on the spatial domain values, to yield a set of DCT coefficients corresponding to each selected block of image data. Such a DCT operation can be performed for each color component, e.g., red, green, and blue, in the selected block of image data. Other transformations can be performed in some other implementations, such as a discrete wavelet transform (DWT) operation to yield a set of DWT coefficients.

In FIG. 4, in block 414, spatial domain values of a designated dither matrix, for instance, associated with a designated image pipeline, also can be transformed to a second set of transform domain coefficients. For instance, in FIG. 2, an example of a DCT coefficient matrix D 200 is illustrated for a particular 8×8 spatial domain dither matrix d having known spatial domain values, for instance, in the sRGB color space. As illustrated in FIG. 4, the transformation in block 414 of a spatial domain dither matrix to a transform domain dither matrix can be performed independent of the flow of blocks 404, 408, and 412. In some implementations, the transformation has been carried out before performing the process 400, and in block 416, the second set of transform domain coefficients is simply accessed, e.g., received over a data network or retrieved from a storage medium. In some other implementations, block 414 is performed between blocks 412 and 416. In some other implementations, blocks 414 and 416 are merged, such that the second set of transform domain coefficients are generated when desired to carry out the operations of block 420, described in greater detail below.

Also, in some implementations, when the spatial domain values of the dither matrix are in a different color space than the input image data, the dither matrix values can be converted to the same color space as the input image data, as explained above, so the corresponding transform domain representations are consistent.

In block 420, process 400 includes determining a ratio of the first transform domain coefficients, that is, the transform domain coefficients of the image data, with the coefficients representing the dither matrix in the same transform domain. In particular, block 420 includes determining a ratio of each first transform domain coefficient with a corresponding second transform domain coefficient. In this way, the ratio of input image energy to dither energy at each corresponding transform domain coefficient, representing a point in the transform domain space, can be computed.

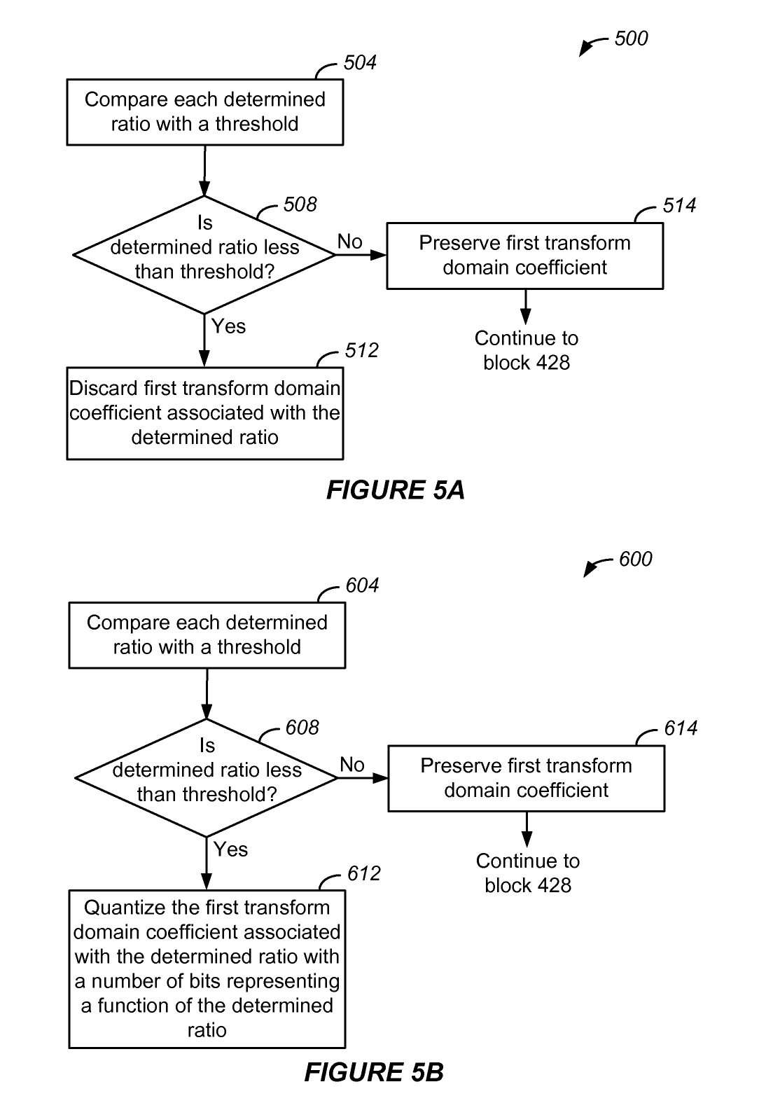

In FIG. 4, process 400 proceeds to block 424, in which the first transform domain coefficients are selectively coded in accordance with the determined ratios. This results in a set of coded first transformed domain coefficients. The selective coding of block 424 can include hard thresholding, in which certain first transform domain coefficients are discarded, i.e., set to zero, when such coefficients meet or exceed a threshold as described with reference to FIG. 5A. Alternatively, block 424 can include soft thresholding, in which the first transform domain coefficients are coded with a number of bits based on image energy relative to dither noise energy, as described with reference to FIG. 5B. In some other implementations, block 424 can include some combination of hard thresholding and soft thresholding, as described in great detail below.

FIG. 5A shows an example of a flow diagram illustrating a selective coding process. As discussed above, the selective coding process 500 can be performed as part of some implementations of a dither-aware image coding process, such as, for example, in block 424 of the dither-aware image coding process illustrated in FIG. 4. Referring to FIG. 5A, the selective coding process begins with comparing each determined ratio with a designated threshold T, in block 504. The numerical value(s) of this threshold T will depend on the particular implementation and can be adjusted and set by experimentation based on available resources and information regarding the particular application. For example, the threshold T can be designated according to various parameters, such as pixel size of the display, viewing distance from the display, and number of colors of the display (e.g., a monochrome display or a RGB display). In some implementations, the threshold T is set to determine the quality level in the coded image. For instance, when T is relatively small, a smaller number of first transform domain coefficients will be set to zero or quantized with fewer than the full number of available bits. This will result in some improvement in the data compression ratio, referring to the size reduction represented by the ratio of the data size of the coded first transform domain coefficients with the data size of the first transform domain coefficients, but the image quality of the coded data will be better preserved. When Tis relatively large, a larger number of image data coefficients will be set to zero or quantized with fewer than the full number of available bits. When T is relatively large, greater improvements in the data compression ratio are possible at the cost of greater possible loss in image quality of coded data. Thus, in general, T can serve as a control mechanism, which trades off compression ratio for image quality, and vice versa.

In FIG. 5A, in block 508, it is determined whether the ratio is less than the threshold. If the determined ratio is less than the threshold, the process transitions to block 512, in which the first transform domain coefficient associated with the determined ratio is discarded. In some implementations, the first transform domain coefficient may be discarded by setting it to zero. Referring back to block 508, if the determined ratio is not less than the threshold, then the first transform domain coefficient is preserved in block 514. Then the process continues to block 428. In other words, when the dither energy at a particular frequency is greater than T x image energy, the transform domain coefficient of the selected portion of the input image data (e.g., a selected block of the input image data) can be discarded, because it can be presumed that the image content will be substantially corrupted by the dither content at that frequency.

FIG. 5B shows an example of a flow diagram illustrating another selective coding process. As discussed above, the selective coding process can be performed as part of some implementations of a dither-aware image coding process, such as, for example, in block 424 of the dither-aware image coding process 400 illustrated in FIG. 4. Referring to FIG. 5B, the selective coding process begins with comparing each determined ratio with a designated threshold as described above with reference to FIG. 5A, in block 604. In block 608, it is determined whether each ratio is less than the threshold. If the determined ratio is less than the threshold, process 600 transitions to block 612, in which the first transform domain coefficient associated with the determined ratio is quantized with a number of bits representing, for example, a function of the determined ratio. Thus, when the dither energy at a particular frequency is greater that T x image energy, then the transform domain coefficient of the selected portion of the input image data (e.g., a selected block of the input image data) can be quantized with a number of bits representing some function of the ratio. Additional details related to the ratio function are further discussed below. Referring back to block 608, if the determined ratio is not less than the threshold, then the first transform domain coefficient is preserved in block 614. Then the process continues to block 428 in FIG. 4.

In some examples of the soft thresholding techniques depicted in FIG. 5B, the first transform domain coefficients (a.k.a., the image coefficients) are not discarded but can be coded with fewer bits. Thus, image coefficients can be considered scaled down or attenuated, in some examples. The function of the ratio with respect to which the image coefficients are quantized can be application dependent. For example, coding an image coefficient can involve dividing the coefficient by the number 2 or some other designated value. In another example, the function can include a non-linear quantization method. According to one example of a non-linear quantization method, any coefficient higher than 50 is set to 100, and any coefficient less than 50 is set to 0. In another example, when dither energy is T x image energy, the image coefficient is divided by T, i.e., the ratio itself.

In some other implementations, selectively coding the first transform domain coefficients in block 424 of FIG. 4 involves a hybrid of the hard thresholding techniques of FIG. 5A and the soft thresholding techniques of FIG. 5B. For example, two thresholds T1 and T2 can be set, to define three determination ranges of coefficient values. For example, in a first region, in which the ratio is less than T1 and T2, first transform domain coefficients are discarded. In a second region, in which the ratio is greater than T1 and less than T2, the soft thresholding of FIG. 5B can be performed. In a third region, in which the ratio is greater than T1 and T2, first transform domain coefficients are preserved.

Referring back to FIG. 4, in block 428, a reverse transformation is performed to transform the coded first transform domain coefficients to spatial domain values, such as sRGB, thus defining a coded portion of the image data. The process 400 of FIG. 4 can be repeated for additional portions, e.g., tiled blocks, of the input image data.

The disclosed processes, apparatus, devices, modules, and systems can be implemented in software, hardware, or some combination thereof. In on example, the disclosed processes are coded on a special-purpose digital signal processing (DSP) chip incorporating DCT transform capabilities. In another example, the disclosed processes are implemented on a customized application specific integrated circuit (ASIC). In some software implementations, the disclosed processes can form a service or other part of a content generation application on a data processing device such as a personal computer, tablet, smartphone, or other data processing device incorporating a particular display. For instance, a user could be provided with a selection in a toolbar of a graphical user interface (GUI) to save an image file in a designated display format. The disclosed processes could also be implemented as software components of content retrieval and/or delivery applications in relation to a display.

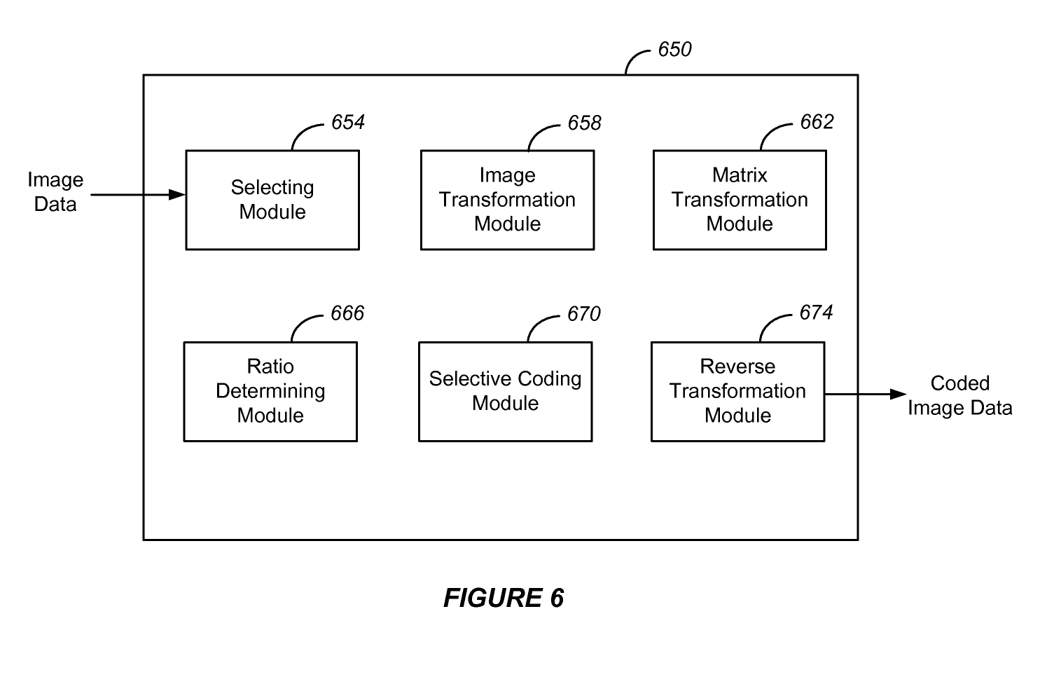

FIG. 6 shows an example of apparatus configured to perform dither-aware image coding. The apparatus 650 of FIG. 6 includes modules, which can be implemented in software, hardware, or combinations thereof. Various examples of suitable software, hardware, and combinations thereof, as described herein can be used to realize the modules of apparatus 650. In some implementations, each module is implemented as a separate software and/or hardware component, while in some other implementations, the various modules are combined into an integral software and/or hardware unit. In FIG. 6, a selecting module 654 is coupled to receive input image data and select a portion of the received image data, as described above in blocks 404 and 408 of process 400. An image transformation module 658 is included in apparatus 650 and configured to perform a transformation from spatial domain values in the selected portion of the image data to first transform domain coefficients, as described above in block 412 of process 400. In the example of FIG. 6, apparatus 650 also includes a matrix transformation module 662 configured to perform a transformation from spatial domain values in the dither matrix to second transform domain coefficients, as described above in block 414 of process 400. A ratio determining module 666 is configured to determine a ratio of each of the first transform domain coefficients with a respective second transform domain coefficient, as described above in block 420 of process 400. A selective coding module 670 is configured to selectively code the first transform domain coefficients in accordance with the determined ratios to define a plurality of coded first transform domain coefficients, as described above in block 424 of FIG. 4. For example, the coding module 670 can be configured to perform process 500 of FIG. 5A or process 600 of FIG. 5B, as described above. The apparatus 650 further includes a reverse transformation module 674 configured to perform a reverse transformation from the coded first transform domain coefficients to spatial domain values to define coded image data, as described above in block 428 of process 400.

The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., electromechanical systems (EMS), MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, electronic test equipment. Thus, the teachings are not intended to be limited to the implementations depicted solely in the figures, but instead have wide applicability as will be readily apparent to one having ordinary skill in the art.

An example of a suitable electromechanical systems (EMS) or MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

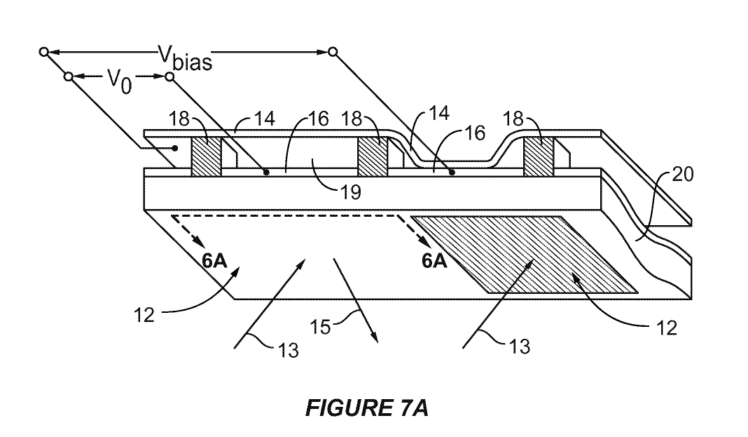

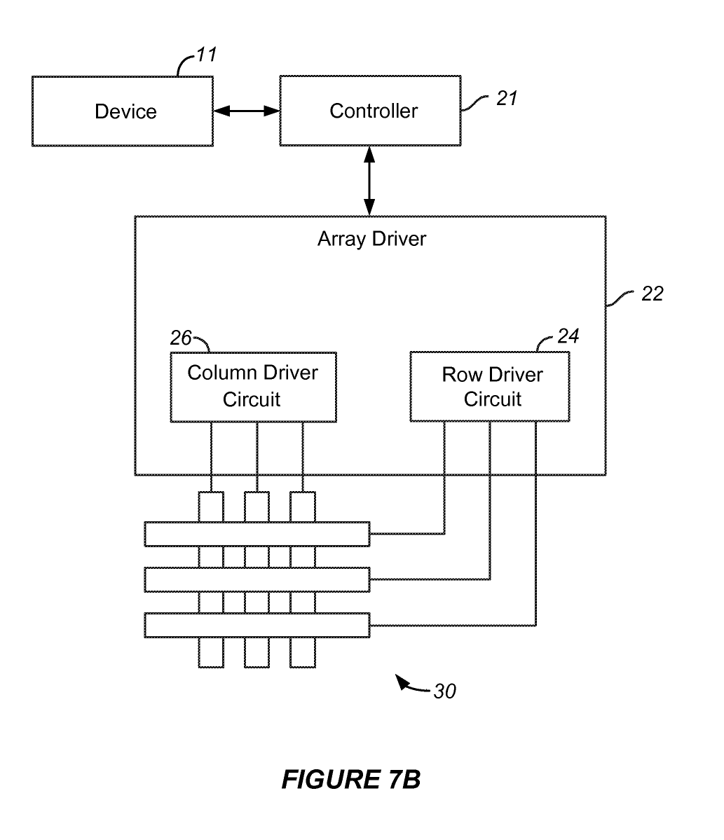

FIG. 7A shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 7A includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V0 applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage Vbias applied across the IMOD 12 on the right is sufficient to maintain the movable reflective layer 14 in the actuated position.

In FIG. 7A, the reflective properties of pixels 12 are generally illustrated with arrows 13 indicating light incident upon the pixels 12, and light 15 reflecting from the IMOD 12 on the left. Although not illustrated in detail, it will be understood by one having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the IMOD 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the IMOD 12 on the left in FIG. 7A, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated IMOD 12 on the right in FIG. 7A. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 7B shows an example of a system block diagram illustrating an electronic device incorporating a 3×3 interferometric modulator (IMOD) display. The electronic device of FIG. 7B represents one implementation in which a device 11 configured to perform dither-aware image coding techniques in accordance with the implementations described above can be incorporated. The electronic device in which device 11 is incorporated may, for example, form part or all of any of the variety of electrical devices and electromechanical systems devices set forth above, including both display and non-display applications.

Here, the electronic device includes a controller 21, which may include one or more general purpose single- or multi-chip microprocessors such as an ARM®, Pentium®, 8051, MIPS®, Power PC®, or ALPHA®, or special purpose microprocessors such as a digital signal processor, microcontroller, or a programmable gate array. Controller 21 may be configured to execute one or more software modules. In addition to executing an operating system, the controller 21 may be configured to execute one or more software applications, including a web browser, a telephone application, an email program, or any other software application.

The controller 21 is configured to communicate with device 11. The controller 21 also can be configured to communicate with an array driver 22. The array driver 22 can include a row driver circuit 24 and a column driver circuit 26 that provide signals to, e.g., a display array or panel 30. Although FIG. 7B illustrates a 3×3 array of IMODs for the sake of clarity, the display array 30 may contain a very large number of IMODs, and may have a different number of IMODs in rows than in columns, and vice versa. Controller 21 and array driver 22 may sometimes be referred to herein as being “logic devices” and/or part of a “logic system.”

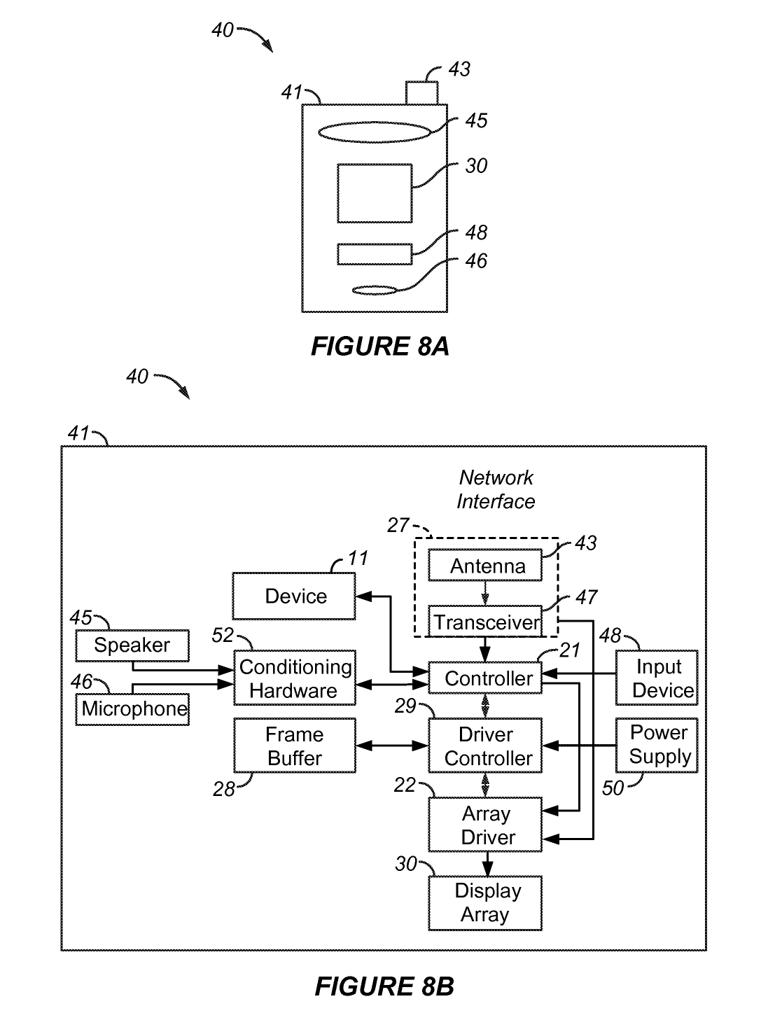

FIGS. 8A and 8B show examples of system block diagrams illustrating a display device 40 that includes a plurality of interferometric modulators. Display device 40 represents one example of an electronic device as described above. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 8B. The display device 40 includes a housing 41 and can include additional components at least partially enclosed therein. For example, the display device 40 includes a network interface 27 that includes an antenna 43, which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43. Apparatus configured to perform dither-aware image coding techniques as described above can be incorporated in transceiver 47.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level. Controller 21 is also configured to interact with device 11 to perform desired operations.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components. In one implementation, device 11 is incorporated as a component of conditioning hardware 52.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and systems described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a non-transitory tangible computer-readable medium. The steps of a method or algorithm disclosed herein may be implemented in a processor-executable software module which may reside on such a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A process comprising:
receiving image data;
selecting a portion of the received image data;
performing a first transformation from a first plurality of spatial domain values in the selected portion of the image data to a first plurality of transform domain coefficients;
accessing a second plurality of transform domain coefficients defined by a second transformation from a second plurality of spatial domain values in a designated dither matrix;
determining a ratio of each of the first transform domain coefficients with a respective one of the second transform domain coefficients;
selectively coding the first transform domain coefficients in accordance with the determined ratios to define a plurality of coded first transform domain coefficients; and
performing a reverse transformation from the coded first transform domain coefficients to a third plurality of spatial domain values defining a coded portion of the image data.

2. The process of claim 1, wherein the first transformation is a discrete cosine transform (DCT).

3. The process of claim 1, wherein the first transformation is a discrete wavelet transform (DWT).

4. The process of claim 1, wherein selectively coding the first transform domain coefficients includes:
comparing one of the determined ratios with a threshold; and
discarding one of the first transform domain coefficients associated with the one determined ratio if the one determined ratio is less than the threshold.

5. The process of claim 1, wherein selectively coding the first transform domain coefficients includes selectively quantizing the first transform domain coefficients.

6. The process of claim 5, wherein selectively quantizing the first transform domain coefficients includes:
comparing one of the determined ratios with a threshold; and
quantizing one of the first transform domain coefficients associated with the one determined ratio with a number of bits representing a function of the one determined ratio if the one determined ratio is less than the threshold.

7. The process of claim 1, wherein the image data has a first tone-level, and wherein the dither matrix is associated with an image pipeline of a display device having a second tone-level lower than the first tone-level.

8. The process of claim 1, further comprising:
performing a compression operation on the coded portion of the image data.

9. The process of claim 1, wherein the received image data has been compressed prior to the first transformation.

10. Apparatus comprising:
a selecting module configured to select a portion of received image data;
an image transformation module configured to perform a first transformation from a first plurality of spatial domain values in the selected portion of the image data to a first plurality of transform domain coefficients;
a ratio determining module configured to determine a ratio of each of the first transform domain coefficients with a respective one of a second plurality of transform domain coefficients, the second transform domain coefficients defined by a second transformation from a second plurality of spatial domain values in a designated dither matrix;
a selective coding module configured to selectively code the first transform domain coefficients in accordance with the determined ratios to define a plurality of coded first transform domain coefficients; and
a reverse transformation module configured to perform a reverse transformation from the coded first transform domain coefficients to a third plurality of spatial domain values defining a coded portion of the image data.

11. The apparatus of claim 10, further comprising:
a compression module configured to:
perform a compression operation on the coded portion of the image data.

12. The apparatus of claim 10, further comprising:
a compression module configured to:
perform a compression operation on the received image data prior to the first transformation.

13. The apparatus of claim 10, wherein first the transformation is a discrete cosine transform (DCT).

14. The apparatus of claim 10, wherein the first transformation is a discrete wavelet transform (DWT).

15. The apparatus of claim 10, wherein the selective coding module is configured to:
compare one of the determined ratios with a threshold; and
discard one of the first transform domain coefficients associated with the one determined ratio if the one determined ratio is less than the threshold.

16. The apparatus of claim 10, wherein the selective coding module is configured to:
selectively quantize the first transform domain coefficients.

17. The apparatus of claim 16, wherein the selective coding module is configured to:
compare one of the determined ratios with a threshold; and
quantize one of the first transform domain coefficients associated with the one determined ratio with a number of bits representing a function of the one determined ratio if the one determined ratio is less than the threshold.

18. The apparatus of claim 10, wherein the image data has a first tone-level, and wherein the dither matrix is associated with an image pipeline of a display device having a second tone-level lower than the first tone-level.

19. The apparatus of claim 10, further comprising:
a display;
a processor configured to communicate with the display, the processor being configured to process image data; and
a memory device configured to communicate with the processor.

20. The apparatus of claim 19, further comprising:
a driver circuit configured to send at least one signal to the display; and
a controller configured to send at least a portion of the image data to the driver circuit.

21. The apparatus of claim 19, further comprising:
an image source module configured to send the image data to the processor.

22. The apparatus of claim 21, wherein the image source module includes at least one of a receiver, transceiver, and transmitter.

23. The apparatus of claim 19, further comprising:
an input device configured to receive input data and to communicate the input data to the processor.

24. Apparatus comprising:
means for receiving image data of an image, the image data having a first tone-level; and
means for performing dither-aware coding on the image data before transferring the data to a display device having a second tone-level lower than the first tone-level.

25. The apparatus of claim 24, wherein the means for performing dither-aware coding includes:
means for selecting a portion of the received image data;
means for performing a first transformation from a first plurality of spatial domain values in the selected portion of the image data to a first plurality of transform domain coefficients;
means for determining a ratio of each of the first transform domain coefficients with a respective one of a second plurality of transform domain coefficients, the second transform domain coefficients defined by a second transformation from a second plurality of spatial domain values in a designated dither matrix;
means for selectively coding the first transform domain coefficients in accordance with the determined ratios to define a plurality of coded first transform domain coefficients; and
means for performing a reverse transformation from the coded first transform domain coefficients to a third plurality of spatial domain values defining a coded portion of the image data.

26. The apparatus of claim 24, further comprising:
means for performing a compression operation on the coded portion of the image data.

27. The apparatus of claim 24, further comprising:
means for performing a compression operation on the received image data prior to the first transformation.

28. A non-transitory tangible computer-readable storage medium storing instructions executable by a computer to perform a process, the process comprising:
receiving image data;
selecting a portion of the received image data;
performing a first transformation from a first plurality of spatial domain values in the selected portion of the image data to a first plurality of transform domain coefficients;
accessing a second plurality of transform domain coefficients defined by a second transformation from a second plurality of spatial domain values in a designated dither matrix;
determining a ratio of each of the first transform domain coefficients with a respective one of the second transform domain coefficients;
selectively coding the first transform domain coefficients in accordance with the determined ratios to define a plurality of coded first transform domain coefficients; and
performing a reverse transformation from the coded first transform domain coefficients to a third plurality of spatial domain values defining a coded portion of the image data.

29. The non-transitory tangible computer-readable storage medium of claim 28, wherein selectively coding the first transform domain coefficients includes:
comparing one of the determined ratios with a threshold; and
discarding one of the first transform domain coefficients associated with the one determined ratio if the one determined ratio is less than the threshold.

30. The non-transitory tangible computer-readable storage medium of claim 28, wherein selectively coding the first transform domain coefficients includes:
comparing one of the determined ratios with a threshold; and
quantizing one of the first transform domain coefficients associated with the one determined ratio with a number of bits representing a function of the one determined ratio if the one determined ratio is less than the threshold.
